(19) United States
(12) Patent Application Publication
(10) Pub. No.: US 2013/0208790 A1
(43) Pub. Date: Aug. 15, 2013

(54) PICTURE CODING AND DECODING

(71) Applicant: Thomas Davies, Guildford (GB)

(72) Inventor: Thomas Davies, Guildford (GB)

(73) Assignee: British Broadcasting Corporation, London (GB)

(21) Appl. No.: 13/809,138

(22) PCT Filed: Jul. 11, 2011
(86) PCT No.: PCT/GB2011/051296

§ 371 Date: Apr. 17, 2013

(30) Foreign Application Priority Data
Jul. 9, 2010 (GB) 1011601.0

(51) Int. Cl. H04N 7/26

(52) U.S. Cl. CPC H04N 19/00781
USPC 375/240.03; 375/240.12

(57) ABSTRACT

An image encoder utilising a transformation operating between a spatial domain and a DCT or other transform domain, employs the steps of forming a prediction; subtracting the prediction to form a difference; and quantising the difference in a transform domain, where the prediction is formed in the transform domain and the transform domain prediction is weighted.

This invention relates to methods and apparatus for encoding and decoding pictures and in the most important example for encoding and decoding video.

In state-of-the-art systems such as AVC/H264 [see ITU-T Recommendation H.264 “Advanced video coding for generic audiovisual services”] multiple forms of intra and motion compensated prediction are used in order to remove correlation from pictures prior to encoding. Instead of coding a block in isolation, a residue is formed by subtracting a prediction from the block before decoding. In intra coding, preceding data (for example, to the left and above the block) may be used as the basis for constructing a prediction block, using a predefined set of prediction modes. These modes include average or DC prediction or directional or angular extrapolation. Motion compensated prediction may be employed using motion vectors from preceding or succeeding pictures. Of course the prediction mode and the motion vectors must be conveyed to the downstream decoder.

If a good prediction can be found, the residue left after subtraction of the prediction will be small and the efficiency of coding will be expected to be high. Accordingly considerable efforts are made to improve predictions. In practical applications however, situations will inevitably arise where residues are not always small.

Aspects of this invention seek to improve coding efficiency in situations where prior art systems would produce residues above optimum levels.

Accordingly, the invention consists in one aspect in a method of encoding an image utilising a transformation operating between a spatial domain and a transform domain, comprising the steps of forming a prediction; subtracting the prediction to form a difference; and quantising the difference in a transform domain, characterised in that the prediction is formed in the transform domain and in that the transform domain prediction is weighted.

In another aspect the invention consists in a method of decoding an image utilising a transformation operating between a spatial domain and a transform domain, comprising the steps of receiving a difference; inverse quantising the difference; forming a prediction in the transform domain; weighting the prediction according to a transform domain prediction weighting matrix; adding the weighted prediction to the difference; and applying an inverse transform.

The invention will now be described by way of example with reference to the accompanying drawings, in which:

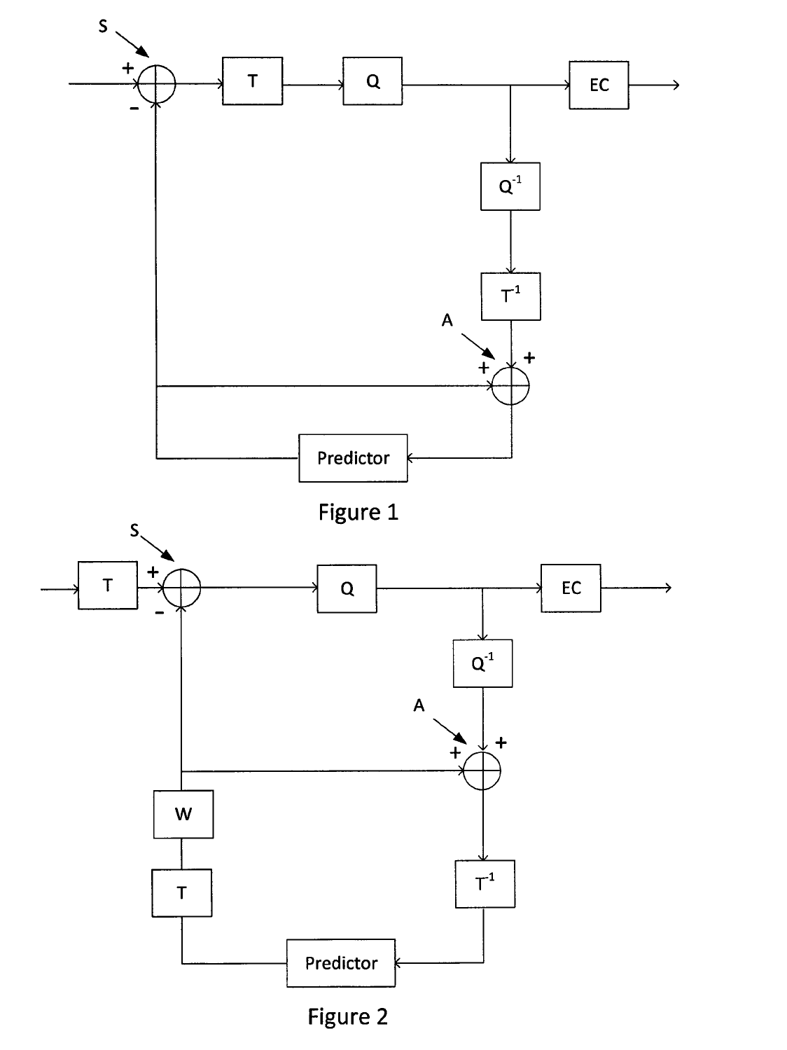

FIG. 1 illustrates prior art video coding in block diagram format;

FIG. 2 illustrates an encoder embodiment of the present invention in the same format; and

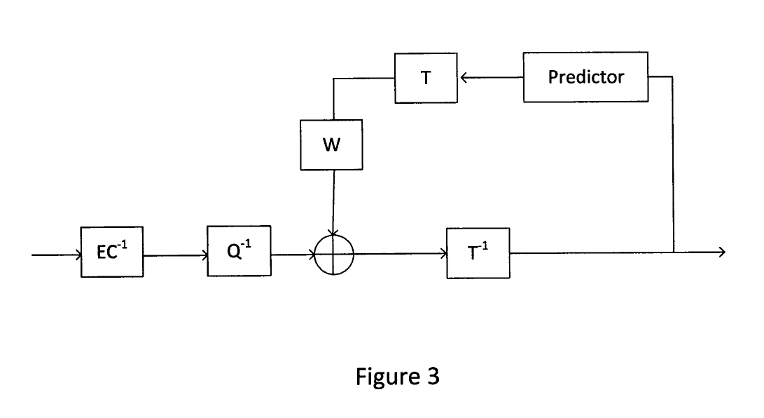

FIG. 3 illustrates an embodiment of a decoder embodiment of the present invention.

Referring first to FIG. 1, in the well-known arrangement, an input video signal is taken to a subtractor S in which a prediction is subtracted. The residue left after this subtraction passes to a transform unit T which performs a transform from the spatial mode in which the block is represented by pixel values to a transform domain in which the block is represented by transform coefficients. Typically the DCT transform is utilised. The transform coefficients are then quantised in quantiser Q and the quantised coefficients passed to an entropy coding unit EC which, for example, may apply run-length coding.

The output of the predictor unit is taken both to the adder A to reconstruct the block and to the subtractor S for subtraction of the prediction from the input, the same prediction therefore being used both for subtraction and reconstruction.

After the adder A, the reconstructed block is taken to the input of the predictor for storage and use in subsequent predictions. By incorporating a suitable delay, the predictor can be made causal and the predictions exactly reproducible by a decoder.

Turning now to FIG. 2, an embodiment of the present invention is illustrated in the same format. A key distinction will immediately be seen in that the prediction that is subtracted to form the residue is a prediction in the transform domain and not in the spatial domain. In this example, this is achieved by moving the conventional transform unit T upstream of the subtractor S and by adding a further like transform unit T at the output of the predictor. Correspondingly the conventional inverse transform block T⁻¹ is moved beneath (in the Figure) the adder A so that the addition likewise occurs in the transform domain.

The advantages that can be achieved from this arrangement, despite the increase in complexity through requiring an additional transform unit will now be described. At the same time, the function of weighting unit W will be explained.

The present inventor has recognised that predicting a block is logically equivalent to predicting the DCT (or any other linear transform) coefficients of that block by the corresponding coefficients of a prediction block. This is because the linearity of the transform means that the subtraction can be done in the transform domain just as well as the picture domain. In the presence of a trivial weighting unit W, in which all weights are unity, and in the case that a true linear transform T is used, the arrangement of FIG. 2 will produce the same quantised coefficients as the arrangement of FIG. 1. If T is not a true linear transform (for example an integer approximation involving some rounding, as in the case of the transforms in H.264), the FIG. 2 arrangement will produce the same or nearly the same coefficients as FIG. 1, in the presence of a trivial weighting unit. Following the teaching of the present invention, the prediction which now takes the form of a matrix of transform coefficients can be regarded as a set of individual predictors for each transform coefficient in turn.

In a general sense, predictors are likely to vary one from the next in the accuracy of the prediction and thus in the size of the residue they leave after subtraction. In the general case, this variation in accuracy may essentially be random. In the specific case where the predictors are transform coefficients, the variation in accuracy between those individual predictors—because they are related one to the other by frequency relationships—will often have a systematic element. This offers the opportunity of improving the overall prediction of the picture block by weighting the individual predictors (that is to say the transform coefficients) to increase the relative contribution of those predictors having higher accuracy and to reduce the relative contribution of those predictors having lower accuracy. This is achieved in FIG. 2 by applying a different multiplicative weight to each coefficient within the prediction block in the weighting unit W.

In one architecture, a set of weights is determined by an encoder for an area of a picture, and signalled to the decoder. For example, two-pass encoding may be used, whereby in a first pass an encoder chooses prediction modes based on an un-weighted prediction, and then determines the optimum prediction weights for each prediction mode. These are then used in a second encoding pass for improved prediction and signalled to the decoder.

One approach to the choice of prediction weights would be to use the theory provided by Wiener for noise reduction and signal estimation.

Thus, given a signal Y, which here can be viewed as representing values to be predicted in a video system, and another signal X, which can be viewed in this case as representing a prediction value from previously decoded data, the process of prediction replaces Y by a residue variable:

R=−X

If X and Y are modeled as random variables with statistics that are assumed are known, Wiener theory shows that the expected size of the residue R can be reduced by using an appropriate weight in the prediction.

The set R(λ) of weighted residues can be formed according to:

R(λ)=Y−λX

The best λ to choose, in a mean-square sense, is the one that minimizes:

### E(R(λ)²)=E(Y²)−2λE(XY)+λ²E(X²)

where E is the expectation operator. This is a minimum when λ is set to:

$$\frac{E ( XY )}{E ( {X}^{2} )}$$

as can be seen by differentiating with respect to λ.

The Wiener theory of multiple prediction is a simple extension of the single predictor case.

Here, a vector X=(X₀, . . . ,Xₙ₋₁)_{T} of random variables which may be used to predict the random variable Y. The classical Wiener solution is to determine the weighting vector Λ□ by the relationship:

Λ=A⁻¹H

where A=Aut(X,X)=(E(XᵢXⱼ))_{i,j} is the autocovariance of the system of variables X and H=(E(XᵢY))ᵢ is the cross-covariance vector with the target Y. By this means several different predictions may be combined, for example in bi-directional motion compensation.

Computing the autocovariance matrix and inverting it are usually expensive operations, so various adaptive methods such as the Least Mean Squares (LMS) and the Recursive Least Squares (RLS) algorithms have been developed to compute Λ incrementally and converge on an ideal or approximately ideal solution.

With each of the random variables Y_{i,j} corresponding to the DCT coefficient in position (i, j) for the current block and X_{i,j} corresponding to the DCT coefficient in position (i, j) for the predicting block, then for each (i, j) the following residue can be formed:

R_{i,j}(λ)=Y_{i,j}−X_{i,j}

An optimum λ=λ(i, j) can be determined for each position and provided to the weighting unit W for weighting of the respective transform coefficients.

An encoder may also take into account the bit rate required to signal the additional weights, performing rate-distortion optimisation of the quality gain versus this additional rate. In this case, depending on the method for coding the weights, Wiener weights may not be optimum and the weights will be chosen to maximise the overall improvement in rate-distortion terms.

Although treating the DCT (or other transform) coefficients as individual predictors seems like a very large increase in prediction parameters, there are three factors to bear in mind. Firstly, many DCT coefficients in the predicting block will be zero, and since the prediction is known to the decoder, the number of prediction parameters can be reduced by discarding parameters associated with zero prediction coefficients. Secondly, the decoder can estimate the weighting matrices itself because it has access to the quantised values of the prediction residue, and so can calculate weights based on correlations in previously reconstructed data, which will approximate the weights computed at the encoder and may be used to predict the encoder-derived weights. Thirdly, the encoder can always incorporate the size of the coded weighting matrices into its rate-distortion calculation.

A natural choice for organising the application of prediction weights would be to divide the picture into a number of square or rectangular areas, for example using a quad-tree decomposition. Within each area, comprising a number of blocks, a common set of weights may be used. The quad-tree decomposition could be adapted to the characteristics of the picture and the particular decomposition also signalled to the decoder.

In order to reduce the potentially large bit rate occupied by signalling weighting matrices for possibly very many different prediction modes explicitly, a relatively small number of predefined matrices could be defined, and a matrix identified by signalling an index into this set.

The sets of possible matrices (and hence the meaning of a weighting index) would very likely depend upon the prediction mode chosen. For example, in horizontal prediction, the matrix elements would only apply to the first column of the DCT coefficients; in vertical prediction, they would only apply to the first row.

A natural set of matrices would include an un-weighted predictor, and might also include a varying degree of low-pass filtering. In many prediction applications, the DC term is a special case, and it might be advisable to vary the weights for DC and AC terms separately.

As has been noted, the DCT is only one example of a transformation; the present invention can be used with a variety of transformations, the wavelet transformation being another important example.

It will be seen in particular from FIG. 2 that in this example the predictor itself operates in the spatial domain and can accordingly be a conventional intra or motion compensated predictor. The prediction is then formed by transforming the output of that conventional predictor. In certain applications, it may be appropriate for the predictor itself to operate in the transform domain.

An example of a decoder is illustrated in FIG. 3.

The bitstream is passed to an inverse entropy coding unit EC⁻¹ and then to inverse quantiser Q⁻¹. After the adder, an inverse transformation is performed in inverse transform unit T⁻¹ and the results passed to a video output and to the input of a predictor. The output of the predictor passes to a transform unit T. Before the transform mode prediction is passed to the adder, it is weighted at W. The weighting matrix that is applied at the decoder is received from the encoder or derived locally, following for example any of the alternative options outlined above.

It will be understood that the separation of functions between the blocks in the block diagram representations of FIGS. 2 and 3 is for the purpose of illustration. In a practical implementation, functions may be shared or distributed among hardware units or software procedures.

1. A method of encoding an image in an image encoder utilising a transformation operating between a spatial domain and a transform domain, comprising:
forming a prediction;
subtracting the prediction to form a difference; and
quantising the difference in a transform domain,
wherein the prediction is formed in the transform domain and in that the transform domain prediction is weighted.

2. A method according to claim 1 wherein a weighting matrix is defined and a different weight may be applied to each transform domain prediction coefficient.

3. A method according to claim 1, wherein the transformation is applied to image blocks and wherein the weighting varies between image blocks.

4. A method of encoding a succession of images according to claim 1, wherein the weighting varies at least from one image to another.

5. A method according to claim 1, wherein the weighting of the transform domain prediction serves to reduce the relative contribution to the prediction of those transform coefficients having lower accuracy of prediction.

6. A method according to claim 1, wherein the weighting of the transform domain prediction serves to minimise the mean-square error produced by the weighted prediction.

7. A method according to claim 1, wherein the weighting of the transform domain prediction serves to minimise a rate-distortion measure, taking into account the prediction error, the coefficient bit rate and the bit rate required for the weights.

8. A method according to claim 1, wherein the transformation is a linear transformation or an approximation to a linear transformation.

9. A method according to claim 1, wherein a set of weighting matrices is pre-defined.

10. A method according to claim 9 in which an index is encoded to indicate which of a set of weighting matrices is used.

11. A method according to claim 1 in which the applicable weights or sets of weights varies according to the prediction mode or type of prediction.

12. A method according to claim 1 in which the applicable weights or sets of weights are applicable to a group of blocks comprising an area of the picture.

13. A method according to claim 12 in which the applicable areas are formed by means of an adaptive quad-tree decomposition.

14. A method according to claim 1 in which more than one prediction may be combined, each prediction weighted by corresponding weights.

15. A method of decoding an image in an image decoder utilising a transformation operating between a spatial domain and a transform domain, comprising:
receiving a difference;
inverse quantising the difference;
forming a prediction in the transform domain;
weighting the prediction according to a transform domain prediction weighting matrix;
adding the weighted prediction to the difference; and
applying an inverse transform.

16. A method according to claim 15 wherein a different weight may be applied to each transform domain prediction coefficient in said weighting matrix.

17. A method according to claim 15, wherein the transformation is applied to image blocks and wherein the weighting varies between image blocks.

18. A method of decoding a succession of images according to claim 15, wherein the weighting varies at least from one image to another.

19. A method according to claim 15, wherein the weighting of the transform domain prediction serves to reduce the relative contribution to the prediction of those transform coefficients having lower accuracy of prediction.

20. A method according to claim 15, wherein the weighting of the transform domain prediction serves to minimise the mean-square error produced by the weighted prediction.

21. A method according to claim 15, wherein the weighting of the transform domain prediction serves to minimise a rate-distortion measure, taking into account the prediction error, the coefficient bit rate and the bit rate required for the weights.

22. A method according to claim 15, wherein the transformation is a linear transformation or an approximation to a linear transformation.

23. A method according to claim 15, wherein a set of weighting matrices is pre-defined.

24. A method according to claim 23 in which an index is encoded to indicate which of a set of weighting matrices is used.

25. A method according to claim 15 in which the applicable weights or sets of weights varies according to the prediction mode or type of prediction.

26. A method according to claim 15 in which the applicable weights or sets of weights are applicable to a group of blocks comprising an area of the picture.

27. A method according to claim 26 in which the applicable areas are formed by means of an adaptive quad-tree decomposition.

28. A method according to claim 15 in which more than one prediction may be combined, each prediction weighted by corresponding weights.

29. (canceled)

30. A non-transitory computer program product comprising instructions adapted to cause programmable apparatus to perform a method of encoding an image utilising a transformation operating between a spatial domain and a transform domain, comprising:
forming a prediction;
subtracting the prediction to form a difference; and
quantising the difference in a transform domain, wherein the prediction is formed in the transform domain and in that the transform domain prediction is weighted.

31. A non-transitory computer program product comprising instructions adapted to cause programmable apparatus to perform a method of decoding an image utilising a transformation operating between a spatial domain and a transform domain, comprising:
receiving a difference;
inverse quantising the difference;
forming a prediction in the transform domain;
weighting the prediction according to a transform domain prediction weighting matrix;
adding the weighted prediction to the difference; and
applying an inverse transform.
